(19) United States
(12) Patent Application Publication
(10) Pub. No.: US 2024/0380084 A1
(43) Pub. Date: Nov. 14, 2024

(54) Composite Electrode Terminal, Top Cover and Battery

(71) Applicant: JIANGSU ZENERGY BATTERY TECHNOLOGIES CO., LTD., Suzhou, Jiangsu (CN)

(72) Inventors: Shengli CHEN, Suzhou, Jiangsu (CN); Wuyuan ZOU, Suzhou, Jiangsu (CN); Bin JIANG, Suzhou, Jiangsu (CN); Zhikang WU, Suzhou, Jiangsu (CN); Xian ZHOU, Suzhou, Jiangsu (CN)

(21) Appl. No.: 18/691,029

(22) PCT Filed: Sep. 9, 2022
(86) PCT No.: PCT/CN2022/118086

§ 371 Date: Mar. 11, 2024

(30) Foreign Application Priority Data
Sep. 9, 2021 (CN) 202111054135.2

(51) Int. Cl. H01M 50/567; H01M 50/15; H01M 50/176; H01M 50/188; H01M 50/528

(52) U.S. Cl. CPC H01M 50/567; H01M 50/15; H01M 50/176; H01M 50/188; H01M 50/528

(57) ABSTRACT

Disclosed are a composite electrode terminal, a top cover and a battery, which relate to the technical field of batteries; the composite electrode terminal includes an inner electrode terminal and an outer electrode terminal; the inner electrode terminal is provided with a first fitting portion; the outer electrode terminal is provided with a second fitting portion fitting with the first fitting portion; one of the first fitting portion and the second fitting portion is a recessed groove, and the other of the first fitting portion and the second fitting portion is a protrusion; and when the first fitting portion is fitted with the second fitting portion, the circumferential edge of the protrusion is fitted with the circumferential edge of the inner wall of the recessed groove, and the end face of the protrusion is attached to the bottom of the recessed groove.

### CROSS-REFERENCE TO RELATED APPLICATION

This application is a National Stage Filing of the PCT International Application No. PCT/CN2022/118086 filed on Sep. 9, 2022 which claims priority to Chinese Patent Application No. 202111054135.2 filed to the China National Intellectual Property Administration on Sep. 9, 2021 and entitled “Composite Electrode Terminal, Top Cover and Battery”.

### TECHNICAL FIELD

The disclosure relates to the technical field of batteries, and in particular, to a composite electrode terminal, a top cover and a battery.

### BACKGROUND

In the technical field of lithium ion power batteries, an electrode terminal is a component allowing for communication between the inside and the outside of the battery, the electrode terminal has one end connected to a cell inside the battery, and the other end connected to a circuit of an external electric device outside the battery, so that the battery may supply power to the external electric device, and also may achieve charging thereof. Moreover, a negative electrode terminal of the battery is generally made of a copper material, but the copper material is relatively expensive, and thus in order to save costs, generally, a part inside the electrode terminal connected to the cell is kept as the original copper material, so as to ensure the use performance of the battery; however, a part outside the electrode terminal connected to the electric device is made of an aluminum material with a relatively low cost. The copper material and the aluminum material are cooperatively connected by a friction welding manner, so as to form a composite electrode terminal which may not only ensure the use performance of the battery, but also has a relatively low cost.

However, in the related art, the composite electrode terminal connected by using a friction welding manner has a high processing cost, and easily to have faulty soldering occurs during welding, thereby affecting the quality and safety performance of the power battery.

### SUMMARY

Some embodiments of the present disclosure provide a composite electrode terminal having a simple and reliable fitting manner and a low cost, which may effectively ensure the quality, use performance and safety performance of a battery.

The present disclosure provides a top cover and a battery, including the composite electrode terminals as described above. Therefore, the top cover and the battery also have the advantages of low cost, good performance and high quality.

Embodiments of the present disclosure are implemented as follows:

Some embodiments of the present disclosure provide a composite electrode terminal, including:

an inner electrode terminal, provided with a first fitting portion;

an outer electrode terminal, provided with a second fitting portion fitting with the first fitting portion;

one of the first fitting portion and the second fitting portion is a recessed groove, and the other of the first fitting portion and the second fitting portion is a protrusion; and when the first fitting portion is fitted with the second fitting portion, a circumferential edge of the protrusion is fitted with a circumferential edge of an inner wall of the recessed groove, and an end face of the protrusion is attached to the bottom of the recessed groove.

In an embodiment, the inner electrode terminal is provided with an electrode terminal boss, the first fitting portion is the recessed groove arranged on a top wall of the electrode terminal boss, a recessing direction of the recessed groove is opposite to a protruding direction of the electrode terminal boss, the recessing depth of the recessed groove is less than or equal to the protruding height of the electrode terminal boss, and the second fitting portion is a protrusion.

In an embodiment, the inner electrode terminal includes a first electrode terminal body and an electrode terminal boss protruding from the first electrode terminal body, and the first fitting portion is provided on the electrode terminal boss; and the outer electrode terminal includes a second electrode terminal body, and the second fitting portion is provided on the second electrode terminal body; and when the recessed groove is fitted with the protrusion, the second electrode terminal body is attached to the first electrode terminal body.

In an embodiment, the number of the first fitting portion is multiple, and the number of the second fitting portion matches the number of the first fitting portion, so that the multiple second fitting portions and the multiple first fitting portions are fitted in one-to-one correspondence.

In an embodiment, the composite electrode terminal further includes a conductive layer, wherein the conductive layer is arranged between the first fitting portion and the second fitting portion.

Some embodiments of the present disclosure provide a top cover, including:

a top cover plate, provided with a mounting hole; and

the composite electrode terminal of any one of the embodiments above, wherein the composite electrode terminal is inserted into the mounting hole and project from the mounting hole.

In an embodiment, the top cover includes a sealing ring, wherein the sealing ring is sleeved outside the composite electrode terminal, and is configured to simultaneously connect, in a sealing manner, the inner electrode terminal and the inner wall of the mounting hole, and the outer electrode terminal and the inner wall of the mounting hole;

or,

the top cover includes a sealing ring and insulation limiting part, wherein the sealing ring is arranged between the inner electrode terminal and the inner wall of the mounting hole and is configured to connect the inner electrode terminal and the inner wall of the mounting hole in a sealing manner; and the insulation limiting part is provided between the outer electrode terminal and the inner wall of the mounting hole, and is configured to limit the position of the outer electrode terminal relative to the top cover.

In an embodiment, the top cover includes a sealing ring and insulation limiting part; the inner electrode terminal includes a first electrode terminal body and an electrode terminal boss protruding from the first electrode terminal body, and the sealing ring is sleeved outside the electrode terminal boss and is configured for sealing cooperation with the inner wall of the mounting hole; and the insulation limiting part is provided with an inner ring slot and an outer ring slot, the top cover plate further includes an annular protrusion located at the edge of the inner wall of the mounting hole; the outer electrode terminal is inserted into the inner ring slot, and the annular protrusion is inserted into the outer ring slot.

In an embodiment, two mounting holes are provided on the top cover plate, the top cover includes two composite electrode terminals, one composite electrode terminal of the two composite electrode terminals is a negative electrode terminal, and the other composite electrode terminal of the two composite electrode terminals is a positive electrode terminal, and the negative electrode terminal and the positive electrode terminal are respectively mounted at the corresponding mounting holes; the inner electrode terminal of the negative electrode terminal is made of a copper material or an aluminum material, and the outer electrode terminal of the negative electrode terminal is made of an aluminum material; and the materials of the inner electrode terminal and the outer electrode terminal of the positive electrode terminal are both aluminium materials.

In an embodiment, the top cover further includes a current collector plate, wherein the current collector plate and the inner electrode terminal of the composite electrode terminal are integrally formed, and the current collector plate is attached to a side wall of the top cover plate.

Some embodiments of the present disclosure provide a battery, including:

the composite electrode terminals of any one of the embodiments above; or the top cover of any one of the embodiments above.

The embodiments of the present disclosure at least have the following advantages or beneficial effects:

embodiments of the present disclosure provide a composite electrode terminal, On the one hand, the composite electrode terminal does not need to be connected by means of welding, there is no problem of a faulty soldering, it is only necessary to fit the recessed groove with the protrusion by means of stamping or the like, and the composite electrode terminal has advantages of simple and reliable fitting and low cost. On the other hand, in the composite structure formed by fitting of the recessed groove and the protrusion, the inner wall of the groove in the circumferential direction of the recessed groove is tightly fitted with the outer wall in the circumferential direction of the protrusion, and the end face of the protrusion is also tightly attached to the bottom of the recessed groove; therefore, not only the stiffness of the composite electrode terminal may be ensured, but also the electrical conductivity and air tightness performance of the composite electrode terminal may be ensured, thereby effectively ensuring the quality, use performance and safety performance of the composite electrode terminal.

Embodiments of the present disclosure further provide a top cover and a battery, the top cover and the battery including the composite electrode terminals as described above. Therefore, the top cover and the battery also have the advantages of low cost, good performance and high quality.

### BRIEF DESCRIPTION OF THE DRAWINGS

In order to illustrate technical solutions of embodiments of the present disclosure more clearly, hereinafter, accompanying drawings requiring to be used in the embodiments will be briefly introduced. It should be understood that the following accompanying drawings only illustrate certain embodiments of the present disclosure, and therefore shall not be considered as limiting the scope. For a person of ordinary skill in the art, other related accompanying drawings is obtained according to these accompany drawings without any inventive effort.

FIG. 1 is a schematic structural diagram of a top cover provided according to embodiments of the present disclosure;

FIG. 2 is a schematic partial sectional diagram of a top cover provided according to embodiments of the present disclosure;

FIG. 3 is a schematic partial exploded diagram of a top cover provided according to embodiments of the present disclosure;

FIG. 4 is a schematic partial structural diagram of a top cover provided according to embodiments of the present disclosure;

FIG. 5 is a schematic structural diagram of another top cover provided according to embodiments of the present disclosure;

FIG. 6 is a schematic partial sectional diagram of another top cover provided according to embodiments of the present disclosure;

FIG. 7 is a schematic partial exploded diagram of another top cover provided according to embodiments of the present disclosure; and

FIG. 8 is a schematic partial structural diagram of another top cover provided according to embodiments of the present disclosure.

Reference signs: 100—Top cover; 101—Top cover plate; 103—Mounting hole; 104—Composite electrode terminal; 105—Inner electrode terminal; 107—Outer electrode terminal; 109—Cover; 111—Plastic member; 113—First electrode terminal body; 115—Electrode terminal boss; 117—Second electrode terminal body; 119—Accommodating groove; 121—First fitting portion; 123—Second fitting portion; 125—Sealing ring; 127—Insulation limiting part; 129—Inner ring slot; 131—Outer ring slot; 133—Current collector plate; 135—Annular protrusion.

### DETAILED DESCRIPTION OF THE EMBODIMENTS

To make the object, technical solutions, and advantages of embodiments of the present disclosure clearer, hereinafter, the technical solutions in the embodiments of the present disclosure will be described clearly and completely with reference to the accompanying drawings of the embodiments of the present disclosure. Obviously, the embodiments as described are only some of the embodiments of the present disclosure, and are not all of the embodiments. Generally, assemblies of embodiments of the present disclosure as described and illustrated in the accompanying drawings herein may be arranged and designed in various different configurations.

Therefore, the following detailed description of embodiments of the present disclosure provided in the accompanying drawings is not intended to limit the claimed scope of some embodiments of the present disclosure, but merely represent selected embodiments of the present disclosure. All other embodiments obtained by a person of ordinary skill in the art on the basis of the embodiments of the present disclosure without involving any inventive effort shall all fall within the scope of protection of some embodiments of the present disclosure.

It should be noted that similar numerals and letters represent similar items in the following accompanying drawings, and thus once a certain item is defined in one accompanying drawing, it does not need to be further defined and explained in subsequent accompanying drawings.

In the illustration of some embodiments of the present disclosure, it should be noted that orientation or positional relationships indicated by terms such as “center”, “upper”, “lower”, “left”, “right”, “vertical”, “horizontal”, “inner”, “outer”, etc. are orientation or positional relationships based on those as shown in the drawings, or based on orientation or positional relationships of a product of the present disclosure which is conventionally placed during use, and are only used to facilitate the illustration of some embodiments of the present disclosure and to simplify the illustration, rather than indicating or implying that an apparatus or element referred to must have a specific orientation, and be constructed and operated in the specific orientation, and therefore said terms cannot be understood as limiting some embodiments of the present disclosure. In addition, the terms “first”, “second”, “third” and the like are used for distinguished illustration only and cannot be construed as indicating or implying relative importance.

Furthermore, the terms “horizontal”, “vertical”, etc. do not imply that a component needs to be absolutely horizontal or vertical, but may be slightly oblique. For example, “horizontal” merely means that the direction thereof is more horizontal relative to “vertical”, and does not mean that the structure must be completely horizontal, but may be slightly oblique.

In the illustration of some embodiments of the present disclosure, it should be noted that unless specified and limited otherwise, the terms “provide”, “mount”, “connect to”, and “connecting” should be understood broadly, and for example, may be fixed connection, and may also be detachable connection, or integral connection; may be mechanical connection, and may also be electrical connection; and may be direct connection, and may also be indirect connection by means of an intermediate medium, and may also be interior communication between two elements. For a person of ordinary skill in the art, the specific meanings of the described terms in some embodiments of the present disclosure could be understood according to specific situations.

In the related art, an inner electrode terminal and an outer electrode terminal of a composite electrode terminal of a battery usually cooperate by a friction welding manner, and a faulty soldering easily occurs during welding when the inner electrode terminal and the outer electrode terminal are connected by friction welding, so that problems such as electrode terminal falling off easily occur, thereby affecting the quality and safety performance of a power battery. In view of this, the present embodiment provides a battery, in which an inner electrode terminal and an outer electrode terminal of each composite electrode terminal of the battery may be cooperatively connected by means of fitting portions, so that connection by using a welding manner may be avoided, and accordingly the problem of a faulty soldering may be avoided. The battery has advantages of a simple and reliable fitting manner and a low cost, which can effectively ensure the quality, use performance and safety performance of the battery. The structure of the battery will be introduced in detail below.

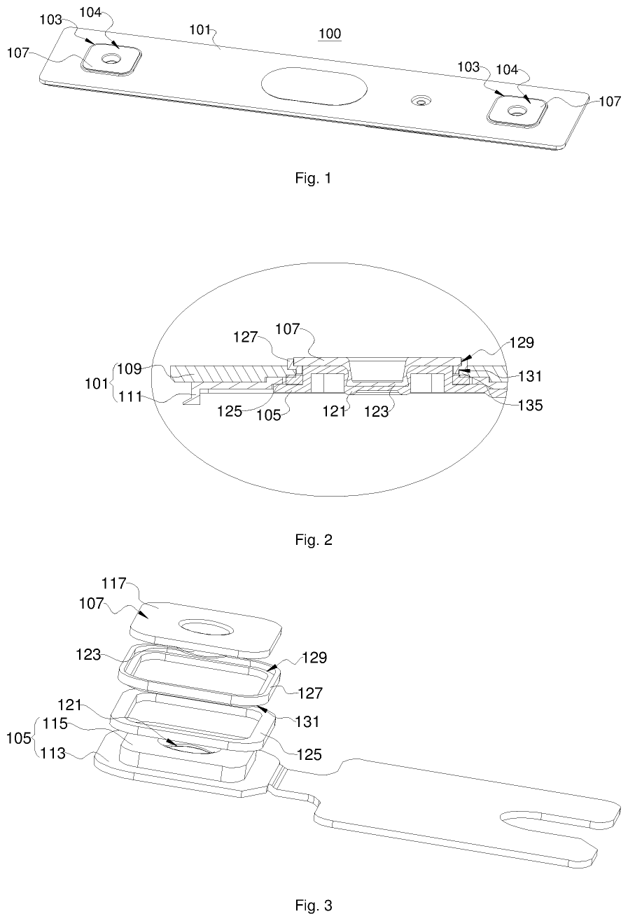

FIG. 1 is a schematic structural diagram of a top cover 100 provided according to the present embodiment. Please refer to FIG. 1, this embodiment provides a battery, which includes a housing (not shown), a cell (not shown) and a top cover 100. The housing is a hollow square structure with one end having an opening; the cell is arranged inside the housing, and the top cover 100 is arranged at the opening of the housing and is electrically connected to the cell.

In detail, please refer to FIG. 1 again, in this embodiment, the top cover 100 specifically includes a top cover plate 101 and composite electrode terminals 104. Two mounting holes 103 are provided on the top cover plate 101, the number of the composite electrode terminals 104 is two, one composite electrode terminal of the two composite electrode terminals is a negative electrode terminal, and the other composite electrode terminal of the two composite electrode terminals is a positive electrode terminal, The negative electrode terminal is inserted into a corresponding mounting hole 103 and projects from the mounting hole 103, an inner side of the negative electrode terminal close to the cell is electrically connected to a negative tab of the cell, and a part of the negative electrode terminal projecting from the mounting hole 103 is configured for being connected to a negative electrode of an external electric device. The positive electrode terminal is also inserted into a corresponding mounting hole 103 and projects from the mounting hole 103, an inner side of the positive electrode terminal close to the cell is electrically connected to a positive tab of the cell, and a part of the positive electrode terminal projecting from the mounting hole 103 is configured for being connected to a positive electrode of the external electric device, so that the battery can perform a normal charging and discharging operation.

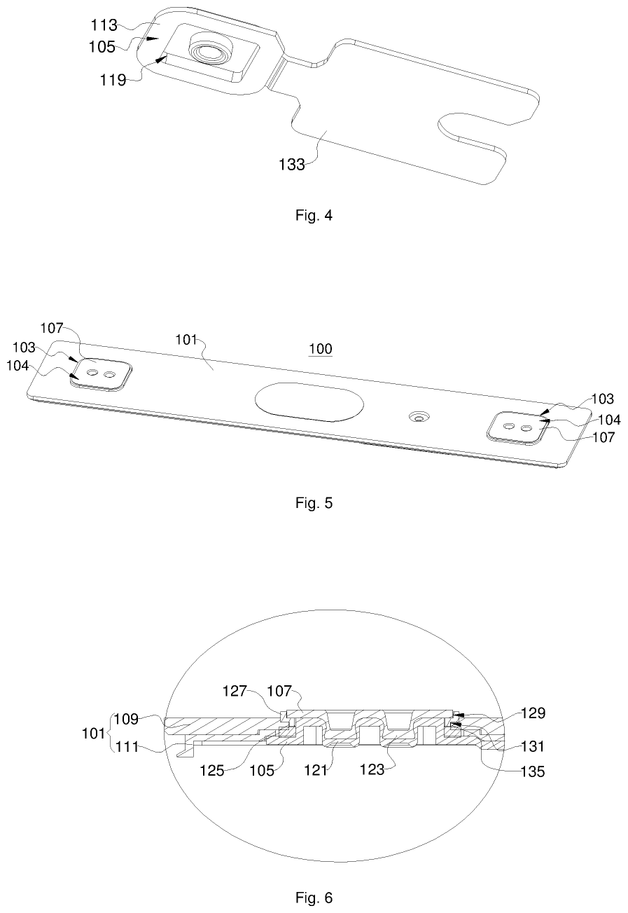

Please refer to FIGS. 1 to 4, in this embodiment, a battery to which the composite electrode terminal 104 is applicable is specifically selected as a lithium ion battery; and when the composite electrode terminal is applicable to a lithium ion battery, regardless of whether it is a positive electrode terminal or a negative electrode terminal, the composite electrode terminal 104 includes an inner electrode terminal 105 and an outer electrode terminal 107. The inner electrode terminal 105 of the negative electrode terminal is configured for being electrically connected to the negative tab of the cell, and the material thereof is selected as a copper material, to ensure the use performance of the battery; and the outer electrode terminal 107 of the negative electrode terminal is configured for being connected to the negative electrode of the external electric device, and the material thereof is selected as an aluminium material, so that the costs may be saved. By the same reasoning, the materials of the inner electrode terminal 105 and the outer electrode terminal 107 of the positive electrode terminal are both aluminium materials, so as to further save manufacturing costs. Certainly, in other embodiments, the composite electrode terminal 104 is applicable to a sodium ion battery, and when the composite electrode terminal is applicable to a sodium ion battery, the positive electrode terminal and the negative electrode terminal of the composite electrode terminal 104 are both made of an aluminum material, which is not limited in this embodiment.

In detail, in order to ensure the stability and reliability of the composite electrode terminal 104, in this embodiment, the inner electrode terminal 105 is provided with a first fitting portion 121. The outer electrode terminal 107 is provided with a second fitting portion 123 fitting with the first fitting portion 121. Furthermore, one of the first fitting portion 121 and the second fitting portion 123 is a recessed groove, and the other of the first fitting portion 121 and the second fitting portion 123 is a protrusion. Moreover, when the first fitting portion 121 is fitted with the second fitting portion 123, the circumferential edge of the protrusion is fitted with the circumferential edge of the inner wall of the recessed groove, and the end face of the protrusion is attached to the bottom of the recessed groove.

By such an arrangement, on the one hand, the inner electrode terminal 105 and the outer electrode terminal 107 of the composite electrode terminal 104 do not need to be connected by means of welding, and accordingly there is no problem of a faulty soldering, the risk of falling off of the electrode terminal can also be reduced, and problems caused by welding, such as blowholes, welding penetration and air leakage are avoided. Moreover, regarding the composite electrode terminal 104 of the present embodiment, it is only necessary to fit the recessed groove with the protrusion by means of stamping or the like, and the composite electrode terminal has advantages of simple and reliable fitting and low cost compared with the welding manner. On the other hand, by using the stamping manner, the inner wall of the groove in the circumferential direction of the recessed groove is tightly fitted with the outer wall in the circumferential direction of the protrusion, and the end face of the protrusion is also tightly fitted with the bottom of the recessed groove; therefore, not only the stiffness of the composite electrode terminal 104 may be ensured, but also the electrical conductivity and air tightness performance of the composite electrode terminal 104 may be ensured, thereby effectively ensuring the quality, use performance and safety performance of the composite electrode terminal 104.

It should be noted that in this embodiment, the inner electrode terminal 105 and the outer electrode terminal 107 form a composite fitting structure of the first fitting portion 121 and the second fitting portion 123 specifically by stamping. The inner electrode terminal and the outer electrode terminal are tightly fitted by stamping, so that while controlling the costs and increasing the efficiency, current-passing and relative fixation effects can also be achieved by means of the structure formed by stamping of the inner electrode terminal and the outer electrode terminal, so that the stability performance, safety performance and use performance of the composite electrode terminal 104 may be fully ensured, and the safety and reliability of the battery may be further ensured. Of course, in other embodiments, the first fitting portion 121 and the second fitting portion 123 is first stamped, and then the first fitting portion 121 and the second fitting portion 123 are fitted by means of adhesive fitting, etc, so as to ensure that the recessed groove is tightly fitted with the protrusion, thereby ensuring the performance of the composite electrode terminal 104, which will not be repeated in this embodiment.

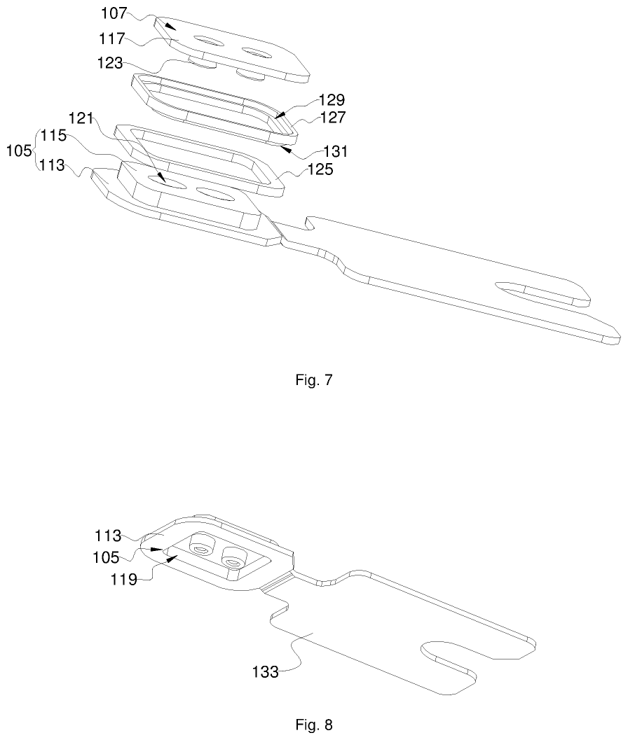

Please refer to FIGS. 1 to 8, in this embodiment, the number of the first fitting portion 121 is multiple or one, and the number of the second fitting portion 123 matches the number of the first fitting portion 121. For example, as shown in FIG. 1 to FIG. 4, the number of the first fitting portion 121 and the number of the second fitting portion 123 are both one; and for another embodiment, as shown in FIG. 5 to FIG. 8, the number of the first fitting portions 121 and the number of the second fitting portions 123 are both two, so as to further ensure the stability and reliability of the composite electrode terminal 104, thereby ensuring the safety performance and use performance of the battery. Certainly, in other embodiments, the number of the first fitting portions 121 and the number of the second fitting portions 123 is adjusted according to requirements, for example, may be set to three, four, and the like, which will not be repeated in this embodiment again.

In detail, regardless of the number of the first fitting portions 121 and the number of the second fitting portions 123, and no matter whether the composite electrode terminal 104 is a positive electrode terminal or a negative electrode terminal, in this embodiment, the inner electrode terminal 105 is provided with an electrode terminal boss 115 in a protruding manner; and the arrangement of the electrode terminal boss 115 facilitates insertion into the mounting hole 103, so that the outer electrode terminal 107 is exposed from the mounting hole 103, to connect to an external electric device. In addition, the first fitting portion 121 is specifically a recessed groove arranged on a top wall of the electrode terminal boss 115, a recessing direction of the recessed groove is opposite to a protruding direction of the electrode terminal boss 115, the recessing depth of the recessed groove is less than or equal to the protruding height of the electrode terminal boss 115, and the second fitting portion 123 is a protrusion.

In the present embodiment, the first fitting portion 121 is a recessed groove, and the second fitting portion 123 is a protrusion. By such an arrangement, when a processing operation is performed, the inner electrode terminal 105 is first stamped out of the electrode terminal boss 115, then the inner electrode terminal 105 and the outer electrode terminal 107 are attached together, and are both stamped out of a composite structure of the recessed groove and the protrusion which are attached, which is simple, convenient and efficient. Moreover, in this embodiment, the recessing direction of the recessed groove is opposite to the protruding direction of the electrode terminal boss 115, so that the stamping direction of the electrode terminal boss 115 is opposite to the stamping direction of the composite structure of the recessed groove and the protrusion, which can further ensure the air tightness and stability after stamping of the composite structure of the recessed groove and the protrusion, and can further ensure the stability and reliability of the composite electrode terminal 104. In addition, as the recessing depth of the recessed groove is less than or equal to the protruding height of the electrode terminal boss 115, no space needs to be occupied in the stamping process, so that the overall structure is more compact and stable, which can further ensure the stability and reliability of the composite electrode terminal 104.

It should be noted that, in this embodiment, the electrode terminal boss 115 obtained by stamping the inner electrode terminal 105 is provided with an accommodating groove 119 at the side close to the cell, the composite stamping structure of the recessed groove and the protrusion formed by simultaneous stamping of the inner electrode terminal 105 and the outer electrode terminal 107 is accommodated in the accommodating groove 119, so as to further ensure the reliability of the structure formed by combining the two while ensuring the safety of the composite stamping structure, thereby sufficiently ensuring the safety and reliability of the battery.

It should also be noted that, in other embodiments, the recessed groove is provided on the outer electrode terminal 107, and the protrusion is provided on the inner electrode terminal 105. In this case, the stamping direction of the electrode terminal boss 115 of the inner electrode terminal 105 is the same as the stamping direction of the composite structure of the recessed groove and the protrusion, which will not be repeated again in this embodiment.

Refer to FIGS. 2 to 4 and FIGS. 6 to 8 again, in this embodiment, the inner electrode terminal 105 specifically further includes a first electrode terminal body 113, and the electrode terminal boss 115 protrudes from the first electrode terminal body 113. Correspondingly, the outer electrode terminal 107 includes a second electrode terminal body 117, and when the recessed groove is fitted with the protrusion, the second electrode terminal body 117 is attached to the first electrode terminal body 113. That is to say, when the inner electrode terminal 105 and the outer electrode terminal 107 are stamped to form the composite stamping structure of the recessed groove and the protrusion, it can also be ensured that the first electrode terminal body 113 and the second electrode terminal body 117 are attached to each other, so that the air tightness, stability and reliability of the composite electrode terminal 104 may be further ensured, and the safety and reliability of the battery may be further improved.

In this embodiment, the recessed groove has a groove opening and a groove bottom opposite to the groove opening, and the inner diameter of the recessed groove first decreases and then increases in a direction from the groove opening to the groove bottom. That is to say, the shape of the recessed groove is set to be larger at the position close to the groove bottom, so that after a fitting structure in which the protrusion and the recessed groove are combined is formed by stamping, the protrusion does not easily fall off from the recessed groove, and the outer electrode terminal 107 is less likely to be separated from the inner electrode terminal 105, so that the structure is more compact, thereby further ensuring the safety and reliability of the battery.

In this embodiment, the composite electrode terminal 104 is provided with a conductive layer (not shown in the figures) according to requirements, wherein the conductive layer is located between the first fitting portion 121 and the second fitting portion 123. The conductive layer is a structure prepared from a relatively soft conductive material, which is stamped together with the inner electrode terminal 105 and the outer electrode terminal 107 to obtain a composite fitting structure of the first fitting portion 121 and the second fitting portion 123, so as to increase the contact area between the first fitting portion 121 and the second fitting portion 123, to enhance the electrical conductivity between the first fitting portion 121 and the second fitting portion 123, thereby further ensuring the safety and reliability of the battery.

Refer to FIGS. 2 to 4 and FIGS. 6 to 8 again, in this embodiment, a current collector plate 133 is further provided on the side of the top cover plate 101 close to the cell, one end of the current collector plate 133 is connected to the inner electrode terminal 105, and the other end of the current collector plate 133 is connected to a tab of the cell, so as to achieve communication between the inside and the outside of the battery. The current collector plate 133 and the first electrode terminal body 113 of the inner electrode terminal 105 are integrally formed. Specifically, a copper material is directly stamped to obtain the connected inner electrode terminal 105 and current collector plate 133, so as to simplify the manufacturing process, increase the manufacturing efficiency, and ensure the stability and reliability of the manufactured composite electrode terminal 104.

It should be noted that, in this embodiment, the current collector plate 133 and the inner electrode terminal 105 are integrally formed, and thus the original assembling sequence of the battery can also be changed by such an arrangement. In detail, in the related art, as the electrode terminal is arranged separately from a current collector plate structure, when the electrode terminal is fitted with a tab of the cell, it is necessary to first mount the current collector plate structure to the top cover, first fit the current collector plate structure with the electrode terminal of the top cover by welding, and then assemble the whole top cover to a battery housing, such that the current collector plate structure is then welded to the tab; such a mounting manner is complicated, and has high precision requirements before and after mounting and welding of the current collector plate structure, thereby also being inconvenient for operation. Accordingly, in this embodiment, the current collector plate 133 and the inner electrode terminal 105 are integrally formed, and in the assembly process, a structure formed by integrally forming the current collector plate and the inner electrode terminal is directly welded to the tab and then is mounted on the top cover, which can effectively simplify the procedure, save costs and increase the assembly and manufacturing efficiency.

Refer to FIGS. 2 to 4 and FIGS. 6 to 8 again, in this embodiment, the top cover plate 101 specifically includes a cover 109 and a plastic member 111 disposed on the side of the cover 109 close to the cell, wherein the plastic member 111 can provide an insulation protection function, so as to further ensure the safety of the battery. Moreover, the mounting hole 103 of the top cover 100 passes through the top cover plate 101 and the plastic member 111. In addition, the inner electrode terminal 105 is attached to the side of the plastic member 111 close to the cell, and the electrode terminal boss 115 of the inner electrode terminal 105 is inserted into the mounting hole 103. Moreover, the current collector plate 133 is also attached to the side of the plastic member 111 close to the cell, so as to be electrically connected to the tab of the cell, thereby ensuring that a charging and discharging operation of the battery is performed efficiently.

In this embodiment, the top cover 100 includes a sealing ring 125 and an insulation limiting part 127. The sealing ring 125 is provided between the inner electrode terminal 105 and the inner wall of the mounting hole 103, and is configured to connect the inner electrode terminal 105 and the inner wall of the mounting hole 103 in a sealing manner; and the insulation limiting part 127 is provided between the outer electrode terminal 107 and the inner wall of the mounting hole 103, and is configured to limit the position of the outer electrode terminal 107 relative to the top cover 100. By the arrangements of the sealing ring 125 and the insulation limiting part 127, the air tightness between the composite electrode terminal 104 and the mounting hole 103 is better, and the fitting structure of the two is more compact and reliable, thereby facilitating ensuring the use performance and safety performance of the composite electrode terminal 104, and further improving the reliability and stability of the battery. Moreover, the material of the insulation limiting part 127 is specifically selected as PPS, which has the advantages of good rigidity and insulation, and thus may also cooperate with the sealing ring 125 to provide good limiting and insulation functions, so as to ensure the compression amount of the sealing ring 125, thereby providing a limiting and insulation effect for the cooperation between the composite electrode terminal 104 and the top cover 100, to further improve the stability and safety of the composite electrode terminal 104, thereby further improving the stability and safety of the battery.

Of course, in other embodiments, the top cover 100 is configured as sleeving the sealing ring 125 outside the whole composite electrode terminal 104 according to requirements, for simultaneously connecting, in a sealing manner, the inner electrode terminal 105 and the inner wall of the mounting hole 103, and the outer electrode terminal 107 and the inner wall of the mounting hole 103; thus, the air tightness between the inner electrode terminal 105 and the outer electrode terminal 107 and the mounting hole 103 is better, and the safety and reliability of the battery may be further ensured, which will not be repeated in this embodiment.

In detail, the first electrode terminal body 113 is inserted into the mounting hole 103, and the sealing ring 125 is specifically sleeved outside the electrode terminal boss 115 and is configured to be tightly fitted with the inner wall of the mounting hole 103. The insulation limiting part 127 is provided with an inner ring slot 129 and an outer ring slot 131, the top cover plate 101 further includes an annular protrusion 135 located at the edge of the inner wall of the mounting hole 103; the outer electrode terminal 107 is inserted into the inner ring slot 129, and the annular protrusion 135 is inserted into the outer ring slot 131. On the one hand, the sealing ring 125 is sleeved outside the electrode terminal boss 115, so that the electrode terminal boss 115 is more tightly and reliably matched with the top cover 100, thereby helping to ensure the reliability and stability of the whole structure obtained after stamping. On the other hand, the insulation limiting part 127 is provided with an inner ring slot 129 and an outer ring slot 131, the inner ring slot 129 is tightly fitted with the second electrode terminal body 117, and thus the air tightness between the second electrode terminal body 117 and the top cover 100 may be ensured, and the outer ring slot 131 can cooperate with the annular protrusion 135, so that the air tightness after the composite electrode terminal 104 is fitted with the sealing ring 125 and the insulation limiting part 127 is further improved, thereby being able to sufficiently ensure the safety and reliability of the battery.

In another embodiment, the upper portion (the end away from the cell) of the sealing ring 125 is arranged to abut against the lower portion (the end close to the cell) of the insulation limiting part 127, so as to further improve the sealing and stability after the whole composite electrode terminal 104 is fitted with the top cover plate 101, thereby further improving the safety and reliability of the battery.

Hereinafter, a preparation process, working principle and beneficial effects of the battery provided by the embodiments of the present disclosure will be described in detail:

when a battery preparation operation is performed, the composite electrode terminals 104 are first provided on the top cover 100; then, the cell is mounted in a housing, the top cover plate 101 is fitted with the housing, the positive tab of the cell is electrically connected to the inner electrode terminal 105 of the positive electrode terminal, and the negative tab of the cell is electrically connected to the inner electrode terminal 105 of the negative electrode terminal. In the process of providing the composite electrode terminals 104 on the top cover plate 101, a copper plate material is first stamped to form a composite structure of the current collector plate 133 and the first electrode terminal body 113 which has the electrode terminal boss 115, so as to serve as the inner electrode terminal 105 of the negative electrode terminal; moreover, an aluminum plate material is stamped to form a composite structure of the current collector plate 133 and the first electrode terminal body 113 which has the electrode terminal boss 115, so as to serve as the inner electrode terminal 105 of the positive electrode terminal; then, two sealing rings 125 are respectively sleeved outside the electrode terminal bosses 115 of the two inner electrode terminals 105, and the electrode terminal bosses 115 protrude after passing through corresponding mounting holes 103, so as to be attached to the inner wall of the mounting hole 103 at corresponding positions via the sealing ring 125; then, two outer aluminium sheets are used as the outer electrode terminals 107, and are respectively attached to the two inner electrode terminals 105, and are respectively stamped to form a negative electrode terminal and a positive electrode terminal of composite structures combining recessed grooves and protrusions; and finally, it is only necessary to respectively arrange two insulation limiting parts 127 between the two outer electrode terminals 107 and the top cover plate 101.

In the described process, on the one hand, the composite electrode terminal 104 does not need to be connected by welding, there is no problem of a faulty soldering, it is only necessary to fit the recessed groove with the protrusion by means of stamping or the like, and the composite electrode terminal has advantages of simple and reliable fitting and low cost. On the other hand, when performing a stamping operation, the inner wall of the groove in the circumferential direction of the recessed groove is tightly fitted with the outer wall in the circumferential direction of the protrusion, and the end face of the protrusion is also tightly fitted with the bottom of the recessed groove; therefore, not only the stiffness of the composite electrode terminal 104 may be ensured, but also the electrical conductivity and air tightness performance of the composite electrode terminal 104 may be ensured, thereby effectively ensuring the quality, use performance and safety performance of the composite electrode terminal 104.

In conclusion, the embodiments of the present disclosure provide a composite electrode terminal 104 having a simple and reliable fitting manner and a low cost, which can effectively ensure the quality, use performance and safety performance of a battery. Embodiments of the present disclosure further provide a top cover 100 and a battery, including the composite electrode terminals 104 as described above. Therefore, the top cover and the battery also have the advantages of low cost, good performance and high quality.

The content above only relates to preferred embodiments of the present disclosure and is not intended to limit some embodiments of the present disclosure. For a person skilled in the art, some embodiments of the present disclosure may have various modifications and variations. Any modifications, equivalent replacements, improvements, etc. made within the spirit and principle of some embodiments of the present disclosure shall all fall within the scope of protection of some embodiments of the present disclosure.

What is claimed is:

1. A composite electrode terminal, comprising:
an inner electrode terminal, provided with a first fitting portion;
an outer electrode terminal, provided with a second fitting portion fitting with the first fitting portion;
one of the first fitting portion and the second fitting portion is a recessed groove, and the other of the first fitting portion and the second fitting portion is a protrusion; the recessed groove and the protrusion are fitted in a stamping or bonding manner, and when the first fitting portion is fitted with the second fitting portion, a circumferential edge of the protrusion is fitted with a circumferential edge of an inner wall of the recessed groove, and an end face of the protrusion is attached to the bottom of the recessed groove.

2. The composite electrode terminal according to claim 1, wherein
the inner electrode terminal is provided with an electrode terminal boss, the first fitting portion is the recessed groove arranged on a top wall of the electrode terminal boss, a recessing direction of the recessed groove is opposite to a protruding direction of the electrode terminal boss, the recessing depth of the recessed groove is less than or equal to the protruding height of the electrode terminal boss, and the second fitting portion is a protrusion.

3. The composite electrode terminal according to claim 1, wherein
the inner electrode terminal comprises a first electrode terminal body and an electrode terminal boss protruding from the first electrode terminal body, and the first fitting portion is provided on the electrode terminal boss; and the outer electrode terminal comprises a second electrode terminal body, and the second fitting portion is provided on the second electrode terminal body; and when the recessed groove is fitted with the protrusion, the second electrode terminal body is attached to the first electrode terminal body.

4. The composite electrode terminal according to claim 1, wherein
the number of the first fitting portion is multiple, and the number of the second fitting portion matches the number of the first fitting portion, so that the multiple second fitting portions and the multiple first fitting portions are fitted in one-to-one correspondence.

5. The composite electrode terminal according to claim 1, wherein
the composite electrode terminal further comprises a conductive layer, wherein the conductive layer is arranged between the first fitting portion and the second fitting portion.

6. A top cover, comprising:
a top cover plate, provided with a mounting hole; and
the composite electrode terminal according to claim 1, wherein the composite electrode terminal is inserted into the mounting hole and extend out of the mounting hole.

7. The top cover according to claim 6, wherein
the top cover comprises a sealing ring and insulation limiting part, wherein the sealing ring is arranged between the inner electrode terminal and the inner wall of the mounting hole and is configured to connect the inner electrode terminal and the inner wall of the mounting hole in a sealing manner; and the insulation limiting part is provided between the outer electrode terminal and the inner wall of the mounting hole, and is configured to limit the position of the outer electrode terminal relative to the top cover.

8. The top cover according to claim 7, wherein
the top cover comprises a sealing ring and insulation limiting part; the inner electrode terminal comprises a first electrode terminal body and an electrode terminal boss protruding from the first electrode terminal body, and the sealing ring is sleeved outside the electrode terminal boss and is configured for sealing cooperation with the inner wall of the mounting hole; and the insulation limiting part is provided with an inner ring slot and an outer ring slot, the top cover plate further comprises an annular protrusion located at the edge of the inner wall of the mounting hole; the outer electrode terminal is inserted into the inner ring slot, and the annular protrusion is inserted into the outer ring slot.

9. The top cover according to claim 6, wherein
two mounting holes are provided on the top cover plate, the top cover comprises two composite electrode terminals, one composite electrode terminal of the two composite electrode terminals is a negative electrode terminal, and the other composite electrode terminal of the two composite electrode terminals is a positive electrode terminal, and the negative electrode terminal and the positive electrode terminal are respectively mounted at the corresponding mounting holes; the inner electrode terminal of the negative electrode terminal is made of a copper material or an aluminum material, and the outer electrode terminal of the negative electrode terminal is made of an aluminum material; and the materials of the inner electrode terminal and the outer electrode terminal of the positive electrode terminal are both aluminium materials.

10. The top cover according to claim 6, wherein
the top cover further comprises a current collector plate, wherein the current collector plate and the inner electrode terminal of the composite electrode terminal are integrally formed, and the current collector plate is attached to a side wall of the top cover plate.

11. A battery, comprising:
the composite electrode terminals according to claim 1; or the top cover according to claim 6.

12. The composite electrode terminal according to claim 2, wherein
the electrode terminal boss has a accommodation groove, and the protrusion and the recessed groove are received in the accommodation groove.

13. The composite electrode terminal according to claim 1, wherein
the recessed groove has a notch and a groove bottom opposite to the notch, and an inner diameter of the recessed groove first decreases and then increases in a direction from the notch to the groove bottom.

14. The top cover according to claim 6, wherein
the top cover comprises a sealing ring, wherein the sealing ring is sleeved outside the composite electrode terminal, and is configured to simultaneously connect, in a sealing manner, the inner electrode terminal and the inner wall of the mounting hole, and the outer electrode terminal and the inner wall of the mounting hole.

15. The top cover according to claim 6, wherein
the inner electrode terminal is provided with an electrode terminal boss, the first fitting portion is the recessed groove arranged on a top wall of the electrode terminal boss, a recessing direction of the recessed groove is opposite to a protruding direction of the electrode terminal boss, the recessing depth of the recessed groove is less than or equal to the protruding height of the electrode terminal boss, and the second fitting portion is a protrusion.

16. The top cover according to claim 6, wherein
the inner electrode terminal comprises a first electrode terminal body and an electrode terminal boss protruding from the first electrode terminal body, and the first fitting portion is provided on the electrode terminal boss; and the outer electrode terminal comprises a second electrode terminal body, and the second fitting portion is provided on the second electrode terminal body; and when the recessed groove is fitted with the protrusion, the second electrode terminal body is attached to the first electrode terminal body.

17. The top cover according to claim 6, wherein
the number of the first fitting portion is multiple, and the number of the second fitting portion matches the number of the first fitting portion, so that the multiple second fitting portions and the multiple first fitting portions are fitted in one-to-one correspondence.

18. The top cover according to claim 6, wherein
the composite electrode terminal further comprises a conductive layer, wherein the conductive layer is arranged between the first fitting portion and the second fitting portion.

19. The battery according to claim 11, wherein
the inner electrode terminal is provided with an electrode terminal boss, the first fitting portion is the recessed groove arranged on a top wall of the electrode terminal boss, a recessing direction of the recessed groove is opposite to a protruding direction of the electrode terminal boss, the recessing depth of the recessed groove is less than or equal to the protruding height of the electrode terminal boss, and the second fitting portion is a protrusion.

20. The battery according to claim 11, wherein
the inner electrode terminal comprises a first electrode terminal body and an electrode terminal boss protruding from the first electrode terminal body, and the first fitting portion is provided on the electrode terminal boss; and the outer electrode terminal comprises a second electrode terminal body, and the second fitting portion is provided on the second electrode terminal body; and when the recessed groove is fitted with the protrusion, the second electrode terminal body is attached to the first electrode terminal body.
